(19) United States
(12) Patent Application Publication
(10) Pub. No.: US 2023/0000128 A1
(43) Pub. Date: Jan. 5, 2023

(54) METHODS OF ROASTING NUTS

(71) Applicant: Elisabeth Burrow, Fergus (CA)

(72) Inventor: Elisabeth Burrow, Fergus (CA)

(21) Appl. No.: 17/857,205

(22) Filed: Jul. 5, 2022

Related U.S. Application Data
(60) Provisional application No. 63/218,467, filed on Jul. 5, 2021.

(51) Int. Cl. A23N 12/08; A23P 20/10

(52) U.S. Cl. CPC A23N 12/083; A23P 20/10

(57) ABSTRACT

Processes for producing roasted nuts are described herein. The processes include mixing bare nuts with maple syrup to coat the bare nuts with the maple syrup and form coated nuts, placing the coated nuts into a cooking apparatus set at a first temperature for a period of time to form roasted nuts, while the coated nuts are roasting in the cooking apparatus, agitating the coated nuts and removing the roasted nuts from the cooking apparatus.

### CROSS-REFERENCE

The present application claims the benefit of U.S. Provisional Patent Application No. 63/218,467 entitled “Methods of Roasting Nuts” filed on Jul. 5, 2021, the entire contents of which are incorporated by reference herein.

### FIELD

The embodiments disclosed herein relate to roasting methods, and more specifically to methods of roasting nuts.

### BACKGROUND

Roasting is one of the most popular methods of nut processing. Roasting nuts aims to improve their sensory properties through the change of colour, developing characteristic taste and flavor substances, as well as improving nut texture.

In the course of roasting nuts, colored Maillard compounds are formed resulting from the reaction between sugars and amino acids. The products of those changes are also compounds responsible for specific and slightly desirable flavors in roasted nuts. Further, roasting nuts decreases their water content which affects texture. Upon heating, nut texture becomes more crispy and delicate.

There are two basic methods of nut roasting: roasting in oil and roasting in the air—so-called dry roasting. Following the first method, nuts are immersed in a vegetable oil heated to an appropriate temperature. When roasting is over, nuts undergo filtering off and oil is removed from their surface. Dry roasting involves a convection and microwave method. In the convection method, nuts are heated by hot air of a proper temperature, moisture and, usually, of determined air flow speed. In a microwave method, which allows to considerably shorten the time of the process, an appropriate radiation power is used. Nuts roasting is usually conducted within the range of temperatures from 200° F. to 350° F. and for periods of time ranging from 5 to 60 minutes.

Each of dry roasting and roasting in oil has disadvantages. Dry roasting does not offer the degree of flavor enhancement as roasting in oil, but roasting in oil provides nuts that hare typically higher in fat than dry roasted nuts as most oils used in nut roasting are high in polyunsaturated fatty acids.

Accordingly, there is a need for new methods of roasting nuts.

### SUMMARY

In accordance with a broad aspect, a process for producing roasted nuts is described herein. The process includes mixing bare nuts with maple syrup to coat the bare nuts with the maple syrup and form coated nuts, placing the coated nuts into a cooking apparatus set at a first temperature for a period of time to form roasted nuts, while the coated nuts are roasting in the cooking apparatus, agitating the coated nuts and removing the roasted nuts from the cooking apparatus.

In at least one embodiment, agitating the coated nuts is repeated at regular intervals during the period of time.

In at least one embodiment, agitating the coated nuts occurs every 4-5 minutes during the period of time.

In at least one embodiment, the agitating the coated nuts includes manually turning over the nuts with an instrument.

In at least one embodiment, the method also includes, prior to mixing the bare nuts with the maple syrup, adding one or more ingredients to the bare nuts.

In at least one embodiment, the first temperature is greater than 350° F.

In at least one embodiment, the first temperature is in a range of about 350° F. to about 450° F.

In at least one embodiment, the first temperature is about 425° F.

In at least one embodiment, the period of time is in a range of about 15 to about 30 minutes, or about 20 to about 25 minutes, or about 22 to about 24 minutes.

In at least one embodiment, agitating the coated nuts encourages sugars within the maple syrup to remain in solution.

In at least one embodiment, the method also includes, after removing the roasted nuts from the cooking apparatus, collecting crystallized sugar from the cooking apparatus.

In at least one embodiment, placing the coated nuts into the cooking apparatus includes placing the coated nuts onto a tray and placing the tray in the cooking apparatus.

In at least one embodiment, the tray is lined with aluminium foil and placing the coated nuts onto the tray includes placing the coated nuts onto the aluminium foil lining the tray.

In at least one embodiment, the bare nuts are selected from the group consisting of: walnuts, hazelnuts, cashews and almonds.

In at least one embodiment, the cooking apparatus is a convection oven.

In at least one embodiment, the maple syrup is a dark maple syrup.

These and other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a block diagram of a method of roasting nuts, according to one embodiment.

Further aspects and features of the example embodiments described herein will appear from the following description taken together with the accompanying drawings.

### DETAILED DESCRIPTION

Various apparatuses, methods and compositions are described below to provide an example of at least one embodiment of the claimed subject matter. No embodiment described below limits any claimed subject matter and any claimed subject matter may cover apparatuses and methods that differ from those described below. The claimed subject matter are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed subject matter. Any subject matter that is disclosed in an apparatus, method or composition described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the FIGURES to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially”, “about” and “approximately” as used herein mean a reasonable amount of deviation of the modified term such that the end result is not significantly changed. These terms of degree should be construed as including a deviation of the modified term, such as 1%, 2%, 5%, or 10%, for example, if this deviation does not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made, such as 1%, 2%, 5%, or 10%, for example, if the end result is not significantly changed.

It should also be noted that, as used herein, the wording “and/or” is intended to represent an inclusive—or. That is, “X and/or Y” is intended to mean X or Y or both, for example. As a further example, “X, Y, and/or Z” is intended to mean X or Y or Z or any combination thereof.

The following description is not intended to limit or define any claimed or as yet unclaimed subject matter. Subject matter that may be claimed may reside in any combination or sub-combination of the elements or process steps disclosed in any part of this document including its claims and FIGURES. Accordingly, it will be appreciated by a person skilled in the art that an apparatus, system or method disclosed in accordance with the teachings herein may embody any one or more of the features contained herein and that the features may be used in any particular combination or sub-combination that is physically feasible and realizable for its intended purpose.

Herein, the term “roasting” refers to a cooking by prolonged exposure to each in an oven or over an open fire.

Herein, the term “maple syrup” refers to a syrup typically made from the xylem sap of sugar maple, red maple, or black maple trees, although it can also be made from other maple species.

Herein, the term “dark maple syrup” refers to maple syrup with invert sugar levels (i.e. glucose and fructose) comprising roughly 30% of total sugar content. The remaining 70% of sugar content is generally sucrose sugar.

Herein, the term “candied” refers to being incrusted with sugar.

Herein, the term “Maillard reaction” refers to a chemical reaction between amino acids and reducing sugars. In the food industry, Maillard reactions are used as a form of non-enzymatic browning, where carbonyl groups of sugar-carbonyl compounds react with nucleophilic amino groups of amino acids in proteins to form a complex mixture of poorly characterized molecules. In food processing applications, the complex mixture of poorly characterized molecules can be responsible for a range of aromas, colors and flavors. Maillard reactions can include a series of consecutive reactions affecting food and biopharmaceutical products involving dozens of compounds. In the process, hundreds of different flavor compounds can be created. These compounds, in turn, break down to form yet more new flavor compounds, and so on. Each type of food has a very distinctive set of flavor compounds that are formed during the Maillard reaction.

Recently, there has been a growing interest in developing systems and methods for roasting nuts. Accordingly, systems and methods for roasting nuts are described herein.

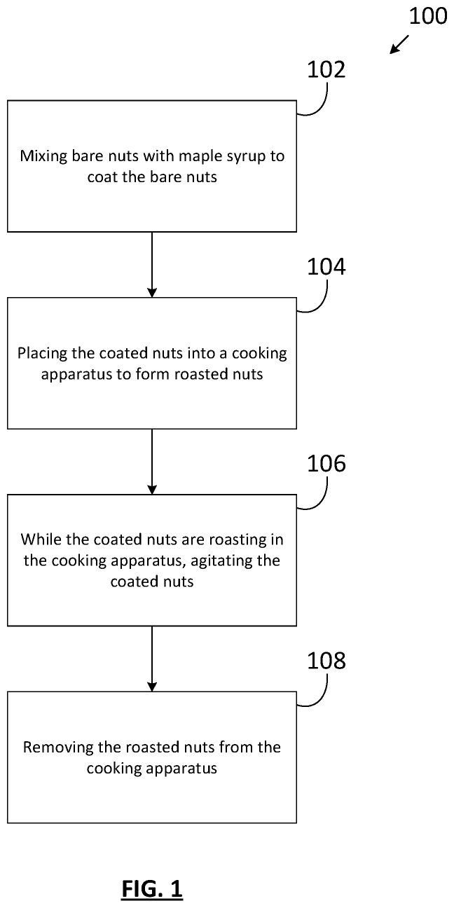

Turning to the figures, FIG. 1 shows a block diagram of a method of roasting nuts, according to one embodiment. Method 100 includes, at a step 102, mixing bare nuts with maple syrup to coat the bare nuts with the maple syrup and form coated nuts. Herein, “bare nuts” refers the edible part of the nut that remains when the shell has been removed or discarded.

The nuts to be roasted by the method 100 can be any dry nut suitable for consuming, such as but not limited to walnuts, hazelnuts, pecans, almonds and the like.

In at least one embodiment, before mixing the bare nuts with the maple syrup, the bare nuts may be refrigerated (e.g. stored at about 4° C.) or frozen (e.g. stored at a temperature less than 0° C.).

The maple syrup mixed with the nuts at step 102 can be a light or golden maple syrup (e.g. 75% or more light transmission), an amber or medium maple syrup (e.g. 50% or more but less than 75% light transmission), a dark maple syrup (e.g. 25% or more but less than 50% light transmission) or a very dark maple syrup (e.g. less than 25% light transmission). In at least one embodiment, the maple syrup is a dark maple syrup produced toward the end of a tapping season.

In at least one embodiment, before mixing the bare nuts with the maple syrup, the maple syrup may be cooled (e.g. have a temperature of about 5° C. or less).

Mixing of the bare nuts with the maple syrup at step 102 may be manual mixing (e.g. by hand) or may be automated (e.g. by a mixing machine). Mixing step 102 may occur for a period of time sufficient to coat each of the nuts with at least a portion of the maple syrup.

In at least one embodiment, prior to mixing the bare nuts with the maple syrup at step 102, the maple syrup is added to the bare nuts. In at least one embodiment, adding the maple syrup to the bare nuts may be by pouring the maple syrup into a bowl holding the bare nuts.

In at least one embodiment, during step 102, about 8 lbs to about 12 lbs of the bare nuts are mixed with about 1 to about 2 lbs of the maple syrup. In at least one embodiment, during step 102, about 8 lbs to about 12 lbs of the bare nuts are mixed with about 1.5 lbs of the maple syrup. In at least one embodiment, during step 102, about 10 lbs of the bare nuts are mixed with about 1 to about 2 lbs of the maple syrup. In at least one embodiment, during step 102, about 10 lbs of the bare nuts are mixed with about 1.5 lbs of the maple syrup. In at least one embodiment, during step 102, when about 10 lbs of the bare nuts are mixed with about 1.5 lbs of the maple syrup, the bare nuts are pecans.

In at least one embodiment, during step 102, about 11 lbs of the bare nuts are mixed with about 1 to about 2 lbs of the maple syrup. In at least one embodiment, during step 102, about 11 lbs of the bare nuts are mixed with about 1.5 lbs of the maple syrup. In at least one embodiment, during step 102, when about 11 lbs of the bare nuts are mixed with about 1.5 lbs of the maple syrup, the bare nuts are walnuts or hazelnuts.

In at least one embodiment, during step 102, about 8 lbs to about 12 lbs of the bare nuts are mixed with about 1000 mL to about 1500 mL of the maple syrup. In at least one embodiment, during step 102, about 8 lbs to about 12 lbs of the bare nuts are mixed with about 1250 mL of the maple syrup. In at least one embodiment, during step 102, about 10 lbs of the bare nuts are mixed with about 1000 mL to about 1500 mL of the maple syrup. In at least one embodiment, during step 102, about 10 lbs of the bare nuts are mixed with about 1250 mL of the maple syrup. In at least one embodiment, during step 102, when about 10 lbs of the bare nuts are mixed with about 1250 mL of the maple syrup, the bare nuts are pecans.

In at least one embodiment, prior to mixing the bare nuts with the maple syrup to coat the bare nuts with the maple syrup and form coated nuts, the bare nuts can be mixed with one or more other ingredients. For instance, the one or more other ingredients may include a dehydrated other ingredient (e.g. freeze-dried) such as but not limited to a dehydrated fruit or a dehydrated vegetable. In at least one embodiment, the one or more other ingredients may include one or more of a seed, a fruit, a root, a bark or another plant substance such as but not limited to chocolate, a spice (e.g. cinnamon) or the like. In at least one embodiment, the one or more other ingredients may be a solid ingredient, a liquid ingredient or both. For instance, when one or more of the other ingredients is a liquid ingredient, the liquid ingredient may comprise alcohol, such as but not limited to beer, whisky, wine or the like.

The one or more other ingredients generally adhere to an outer surface of the bare nuts when the one or more other ingredients are added to and mixed with the bare nuts.

In at least one embodiment, about 0.1 cups to about 2 cups of one or more other ingredients are added to the bare nuts. In at least one embodiment, about 0.25 cups, or about 0.5 cups, or about 1 cup of one or more other ingredients are added to the bare nuts. In at least one embodiment, three other ingredients are added to the bare nuts in a ratio of 4:2:1 relative to each other. For instance, in at least one embodiment, three other ingredients are added to the bare nuts, a first other ingredient, a second other ingredient and a third other ingredient, wherein about 1 cup of the first other ingredient, about 0.5 cups of the second other ingredient and about 0.25 cups of the third other ingredient are added, sequentially to the about 10 pounds of bare nuts.

In at least one embodiment, when the one or more other ingredients are added to and mixed with the bare nuts, the one or more other ingredients and the bare nuts are mixed by hand to provide for the one or more other ingredients to coat, or at least partially coat, the bare nuts.

After mixing the bare nuts with maple syrup to form coated nuts, and optionally, prior to mixing the bare nuts with the maple syrup, mixing the bare nuts with one or more other ingredients, the coated nuts are placed into a cooking apparatus (e.g. an oven) at a first temperature for a first duration of time at a step 104.

In at least one embodiment, when the coated nuts are placed in the cooking apparatus, the temperature of the cooking apparatus is in a range of about 350° F. to about 500° F., or in a range of about 375° F. to about 450° F., or is about 425° F. Placing the nuts in the cooking apparatus at step 104 and leaving the nuts in the cooking apparatus for a duration of time may be referred to as “roasting” the nuts. Roasting the nuts at a temperature above about 350° F., or at about 425° F., as opposed to prior art nut roasting processes that typically operate at temperatures at or lower than about 350° F., provides for the oils on the inside of the nut to increase in temperature more rapidly and to a higher temperature than prior art methods.

In at least one embodiment, the cooking apparatus is an oven such as but not limited to a convection oven.

In at least one embodiment, placing the coated nuts into the cooking apparatus includes placing the coated nuts onto a tray, such as but not limited to a tray lined with parchment paper, tinfoil or the like, and placing the tray into the cooking apparatus.

In at least one embodiment, the period of time is about 15 to about 30 minutes, or about 20 to about 25 minutes, or about 22 to about 24 minutes.

In at least one embodiment, after the step 104 of placing the coated nuts in the cooking apparatus, the coated nuts are agitated at a step 106. Agitating the coated nuts may be by, but is not limited to, turning over, or folding over, or stirring the coated nuts while the coated nuts are in the cooking apparatus. Herein, the term “agitating” generally refers to disturbing or moving the coated nuts to disperse the maple syrup coating the nuts. “Turning over” or “folding over” the coated nuts generally refers to gently turning or flipping over the nuts, for instance, manually with an instrument (e.g. spatula) when the coated nuts are stationary in the cooking apparatus, such as on a tray. Agitating the coated nuts can also be by “stirring” the coated nuts while they are in the cooking apparatus, such as but not limited to stirring the coated nuts by the cooking apparatus. One example of stirring the coated nuts is stirring in the cooking apparatus by a tumbling function, or a tumbler (i.e. an upright drum that rotates vertically; similar to the rotation of a Ferris wheel).

It should be understood that the step 106 of agitating the coated nuts as they are roasting in the cooking apparatus may include agitating the coated nuts directly in the cooking apparatus or temporarily removing the coated nuts from the cooking apparatus to agitate the coated nuts. In both ways, it should be understood that the temperature of the coated nuts does not substantially decrease while they are being agitated.

In at least one embodiment, the coated nuts are agitated intermittently during roasting. For example, in at least one embodiment, the coated nuts may be agitated at regular time intervals while being roasted. For example, the coated nuts may be agitated at irregular time intervals while being roasted. In at least one embodiment, the coated nuts may be agitated by manually turning over or folding over the nuts as they lie on a tray every 4 to 5 minutes while being roasted.

In maple syrup at 66.0° Brix (i.e. typical maple syrup), the sugar in the maple syrup is completely in solution and the solution is stable. As the temperature of the maple syrup increases in the cooking apparatus, the concentration of sugar in the syrup continues to increase as water is lost by evaporation. In the embodiments described herein, the sugar in the maple syrup remains in solution at the temperatures described (e.g. temperatures greater than 350° F.) even though much of the water boils away because the coated nuts are agitated while being roasted. Agitation can cause the sugar in the maple syrup to crystallize and come out of solution until the sugar in solution reaches a stable concentration for its temperature. The maple syrup coating the nuts therefore remains stable and the sugar crystallizes off of the nuts (e.g. on the tray the nuts lie on). Agitating the coated nuts as they are roasting in the cooking apparatus may therefore inhibit the maple syrup from crystallizing on the nuts and may provide for the maple syrup to insulate the nuts for a period of time that would otherwise not be possible at the temperatures described above. If, for example, the maple syrup crystalized on the nuts, the temperature of the nuts would increase beyond a selected temperature and oils within the nuts would cook, resulting in the nuts having a burnt taste.

Further to the above, the nuts that can be roasted by the methods described herein are generally rich in unsaturated fatty acids, but the high degree of unsaturation makes oils inside of the nuts susceptible to oxidation at high temperatures. Oxidative reactions degrade the quality of roasted nuts. Therefore, agitating the nuts during roasting may also provide for reducing the temperature of the nuts and inhibiting the likelihood of burning the nuts and negatively impacting the flavour of the nuts.

Method 100 also includes, at a step 108, removing the roasted nuts from the cooking apparatus.

Optionally, after the roasted nuts are removed from the cooking apparatus at step 108, sugars from the maple syrup can be collected from the cooking apparatus. For instance, sugars from the maple syrup may crystallize on a tray supporting the coated nuts as they are roasted. The sugars that can be collected from the cooking apparatus may be granular in nature and may be reused in other applications, such as but not limited to flavouring purposes.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

What is claimed is:

1. A process for producing roasted nuts, the process comprising:
mixing bare nuts with maple syrup to coat the bare nuts with the maple syrup and form coated nuts;
placing the coated nuts into a cooking apparatus set at a first temperature for a period of time to form roasted nuts;
while the coated nuts are roasting in the cooking apparatus, agitating the coated nuts; and
removing the roasted nuts from the cooking apparatus.

2. The process of claim 1, wherein agitating the coated nuts is repeated at regular intervals during the period of time.

3. The process of claim 2, wherein the agitating the coated nuts occurs every 4-5 minutes during the period of time.

4. The process of claim 1, wherein the agitating the coated nuts includes manually turning over the nuts with an instrument.

5. The process of claim 1, further comprising, prior to mixing the bare nuts with the maple syrup, adding one or more ingredients to the bare nuts.

6. The process of claim 1, wherein the first temperature is greater than 350° F.

7. The process of claim 1, wherein the first temperature is in a range of about 350° F. to about 450° F.

8. The process of claim 1, wherein the first temperature is about 425° F.

9. The process of claim 1, wherein the period of time is in a range of about 15 to about 30 minutes, or about 20 to about 25 minutes, or about 22 to about 24 minutes.

10. The process of claim 1, wherein agitating the coated nuts encourages sugars within the maple syrup to remain in solution.

11. The process of claim 1 further comprising, after removing the roasted nuts from the cooking apparatus, collecting crystallized sugar from the cooking apparatus.

12. The process of claim 1, wherein placing the coated nuts into the cooking apparatus includes placing the coated nuts onto a tray and placing the tray in the cooking apparatus.

13. The process of claim 12, wherein the tray is lined with aluminium foil and placing the coated nuts onto the tray includes placing the coated nuts onto the aluminium foil lining the tray.

14. The process of claim 1, wherein the bare nuts are selected from the group consisting of: walnuts, hazelnuts, cashews and almonds.

15. The process of claim 1, wherein the cooking apparatus is a convection oven.

16. The process of claim 1, wherein the maple syrup is a dark maple syrup.
